(19) United States
(12) Patent Application Publication
(10) Pub. No.: US 2010/0125474 A1
(43) Pub. Date: May 20, 2010

(54) SERVICE EVALUATION ASSESSMENT TOOL AND METHODOLOGY

(76) Inventors: J. Scott HARMON, Portola Valley, CA (US); Gary Dennis, Duluth, GA (US)

Correspondence Address: TRIMBLE NAVIGATION LIMITED C/O WAGNER BLECHER, 123 WESTRIDGE DRIVE, WATSONVILLE, CA, 95076, US

(21) Appl. No.: 12/274,306

(22) Filed: Nov. 19, 2008

(51) Int. Cl. G06Q 10/00

(52) U.S. Cl. 705/7

(57) ABSTRACT

Embodiments of the invention are concerned with providing an integrated data collection platform and for providing an integrated view of relative performance of respective service areas making up an overall service delivery. One embodiment involves a software tool arranged to perform a process for presenting one or more sets of service assessment evaluation data, wherein each set of service assessment evaluation data corresponds to services provided by one or by different service providers; the process comprises the steps of:
providing an integrated data collection platform; and
arranging the integrated data collection platform to receive the one or each set of service assessment evaluation data, and, for each said set, using the data collection platform to:
   identify a quantifiable measure of performance for each member of the set;
   present the set of quantified performance measures in an integrated graphical display area such that relative performance between sets of service assessment evaluation data can be derived.

### FIELD OF THE INVENTION

The present invention relates to a system for providing a service evaluation assessment tool and to a service assessment tool, and is particularly but not exclusively suitable for evaluating the performance of an organisation in relation to service delivery, where the organisation has more than one defined service area providing the overall service delivery.

### BACKGROUND

It is well known for organisations to employ supply chain management to increase organizational effectiveness and achieve such organizational goals as improved customer value, better utilization of resources, and increased profitability. In addition it is known to provide methodologies and instruments for use in measuring supply chain performance. Typical methodologies include measuring, e.g. transport logistics, so as to quantify reliability and responsiveness in order to generate some measure of service effectiveness. One such system is described in US patent application having publication number US 2005-0091001.

In this, and indeed other, known systems, performance monitoring is confined to particular areas of the supply chain, and while each area can be measured using a variety of techniques, this does not provide the organization with an overview of how the supply chain fares at each stage, in particular how the delivery of each various stage compares with that of other stages.

### SUMMARY

In accordance with at least one embodiment of the invention, methods, systems and software are provided for operating an integrated data collection platform and for providing an integrated view of relative performance of respective service areas making up an overall service delivery, as specified in the independent claims. This is achieved by a combination of features recited in each independent claim. Accordingly, dependent claims prescribe further detailed implementations of the present invention.

More specifically, in accordance with a first aspect of embodiments of the present invention, there is provided a method of presenting one or more sets of service assessment evaluation data, each set of service assessment evaluation data corresponding to services provided by one or by different service providers, the method comprising:

providing an integrated data collection platform; and

arranging the integrated data collection platform to receive the one or each set of service assessment evaluation data, and, for each said set, using the data collection platform to:
identify a quantifiable measure of performance for each member of the set; and
present the set of quantified performance measures in an integrated graphical display area such that relative performance between sets of service assessment evaluation data can be established.

Thus embodiments of the invention provide an integrated view of how a company is performing across the various service areas, and importantly highlight how the service areas are performing relative to one another. This enables the organisation to design and develop a structured approach to improving efficiency and business processes across the service areas, starting with those service areas performing most poorly. This is particularly advantageous when costs are an issue, and thus where it is important to effectively focus time, effort and resources into resources and new processes where they are most required. In addition it provides a means of benchmarking where an organisation is—relative to other organisations—and indeed in relation to previous performance of any given organisation.

In an exemplary embodiment the sets of service assessment evaluation data can correspond to management of appointing a task; management of dispatching a task; management of resources dispatched to a task; and task-completion management. Typically service assessment data are captured by customer facing groups within an organisation, since the services that are being assessed are provided to customers.

In one arrangement the integrated data collection platform is arranged to receive the one or each set of service assessment evaluation data via an HTTP communications channel, while in another the integrated data collection platform is arranged to receive the one or each set of service assessment evaluation data via e-mail. In a yet further arrangement the integrated data collection platform is arranged to receive the one or each set of service assessment evaluation data via file transfer. When received via e-mail or file transfer, the data are parsed, e.g. using Optical Character Recognition (OCR) techniques, so as to derive the one or each set of service assessment evaluation data.

When received via an HTTP communications channel, the service provider can first be provided with a URL corresponding to a server arranged to serve said set of service assessment evaluation questions, and the service provider, or service reviewer, can similarly input responses to the questions via the HTTP communications channel.

In a yet further arrangement the method comprises sending to the one or each service provider a software component comprising a set of executable instructions arranged to invoke the integrated data collection platform. The software component can be accompanied by the one or more sets of service assessment evaluation questions, and the software component is configured to receive responses to the questions and present the set of quantified performance measures in an integrated graphical display area on a terminal local to said service provider. For example, the software component and questions can be embodied within an Excel™ file comprising macros embedded therein, or as a Java™ application configured with the requisite functionality.

Conveniently, the method comprises creating a display area comprising a plurality of portions, each portion corresponding to a different set of service assessment evaluation data. Each of the portions comprises a plurality of regions, and each region corresponds to a member of the corresponding set of service assessment evaluation data; for each said set of service assessment evaluation data, points indicative of the quantified performance measures are inserted in a said region corresponding to respective members of the set. In this way the set of quantified performance measures can be presented in an integrated graphical display area and thereby enable relative performance between sets of service assessment evaluation data to be derived.

In one arrangement the integrated service delivery platform manipulates the one or each set of service assessment evaluation data in accordance with one or more predetermined functions so as to generate a weighted or normalised set of service assessment data. Preferably a given set of service assessment data are normalised with respect to other members of the set and indeed the members of a given set of service assessment data can be normalised with respect to members of at least one other set of service assessment data. In another arrangement the assessment data can be weighted on the basis of one or more factors corresponding to the services provided.

In a particularly advantageous embodiment each portion comprises a segment of a two-dimensional entity in the form of a circle, such that each portion comprises a segment of the circle.

Other aspects of the invention comprise a distributed system arranged to perform the method described above, while other aspects comprise a set of software components comprising a set of instructions adapted to perform the method steps described above when executed over such a distributed system.

Further features and advantages of the invention will become apparent from the following description of preferred embodiments of the invention, given by way of example only, which is made with reference to the accompanying drawings.

### BRIEF DESCRIPTION OF THE DRAWINGS

The accompanying drawings, which are incorporated in and form a part of this specification, illustrate and serve to explain the principles of embodiments in conjunction with the description. Unless specifically noted, the drawings referred to in this description should be understood as not being drawn to scale.

FIG. 1 is a schematic block diagram showing an example of a network arrangement in which embodiments of the invention can operate;

FIG. 2 is a schematic block diagram showing storage of sets of service parameters associated with a given organisation;

FIG. 3 is a schematic block diagram showing components of an assessment tool server shown in FIG. 1;

FIG. 4 is a flow diagram showing steps performed by the assessment tool server of FIG. 1 according to an embodiment of the invention;

FIG. 5a is a schematic diagram showing, in tabulated form, questions corresponding to a set of parameters shown in FIG. 2;

FIG. 5b is a schematic diagram showing, in tabulated form, questions corresponding to a different set of parameters shown in FIG. 2;

FIG. 5c is a schematic diagram showing, in tabulated form, questions corresponding to a yet further set of parameters shown in FIG. 2;

FIG. 5d is a schematic diagram showing, in tabulated form, questions corresponding to a yet further still set of parameters shown in FIG. 2;

FIG. 6 is a pictorial representation of a display area into which data generated by the assessment tool server of FIG. 1 are input;

FIG. 7 is a pictorial representation of output generated within the display area of FIG. 6;

FIG. 8 is a flow diagram showing steps performed by the assessment tool server of FIG. 1 according to a further embodiment of the invention;

FIGS. 9a-9c are schematic diagrams showing, in tabulated form, questions corresponding to micro-service areas collectively corresponding to a member of the set of parameters shown in FIG. 2; and

FIG. 10 is a pictorial representation of output generated within a further display area generated by the assessment tool server of FIG. 1.

### DETAILED DESCRIPTION OF THE INVENTION

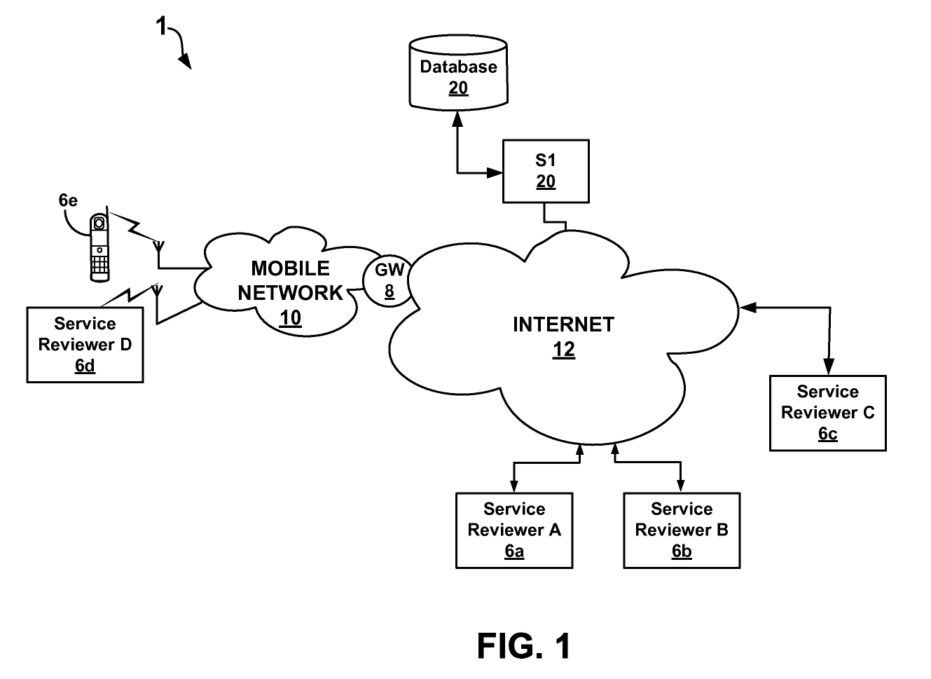

As described above, embodiments of the invention are concerned with an integrated service assessment evaluation method and tool. The nature the evaluation and commensurate functionality of the tool will be described in detail below, but first a description of the infrastructure needed to support some embodiments of the invention will be presented with reference to FIG. 1, which shows an example of a distributed information system 1.

FIG. 1 shows several service reviewer systems A . . . E, each of which can interact with an assessment tool server S1 in order to gain a quantitative measure of the levels of service delivered by various operating arms of their organisation, or indeed of third parties contracted to provide a particular service. In the exemplary embodiments described herein, the organisation is a provider of services, specifically a provider that interacts with a customer in order to place an order for a task to be completed (appointment management); to schedule the allocation of resources to perform the task (work management); to track progress of the resources in attending to and completing the task (asset, or worker management); and to enter into a dialogue with the customer once the task has been completed (delivery management). The service reviewer systems 6a . . . 6e can be software applications running on a fixed or mobile terminal, and communicating with the assessment tool server S1 via e-mail, HTTP or other transport protocols, and involve sending data via fixed and/or wireless networks; an exemplary arrangement of such networks including the Internet 12, and a mobile network 10 is shown in FIG. 1. Further details of exemplary network arrangements are provided at the end of the specification.

There can be one assessment tool server S1 serving a plurality of organisations, as shown in FIG. 1, or there can be one assessment tool server for each organisation. Further, whilst shown as single units in FIG. 1, it will be appreciated that the assessment tool server S1 and database DB1 can comprise a plurality of units distributed in the Internet 12.

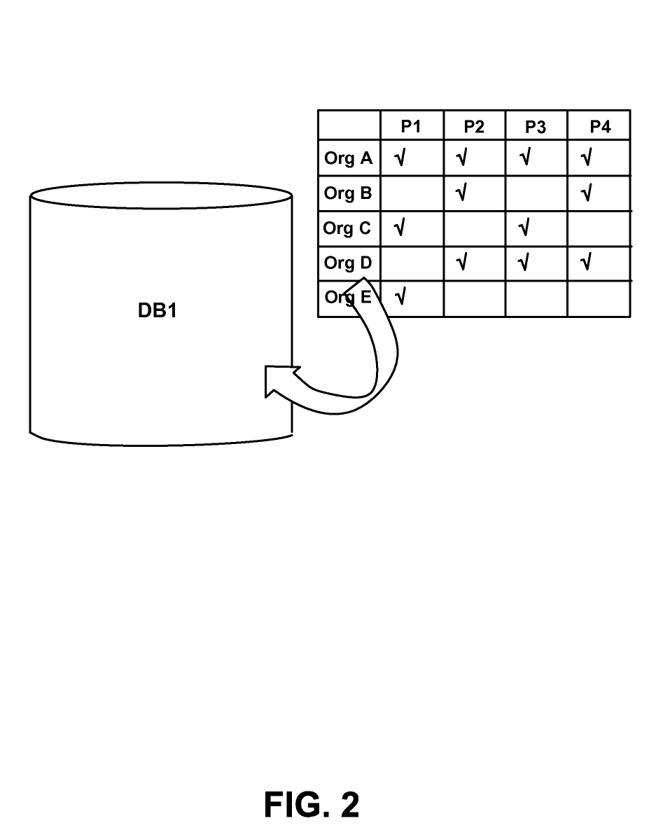

In either configuration, the one or each provider S1 stores data identifying the organisation, in a storage system DB1, together with a list of parameters characterising each of the stages described above. For example, and as shown in FIG. 2, there might be sets P1, P2, P3, P4 characterising each of appointment management, work management, asset management and delivery management, some or all of which might be measured by, and of interest to, the organisation. An exemplary, and non-limiting, list of the parameters making up the sets is shown in Tables 1-4 below:

TABLE 1
Appointment Management (set P1)

The flexibility of the system and/or the process to take customers'
schedules into consideration when setting appointments.
The visibility the CSR has of the capacity to fulfil a committed
appointment and the potential level of integration between the contact
center systems and screens and the dispatch system and database.
The intelligence a CSR has access to with respect to the skills required
to do a specific job for which they are scheduling an appointment.
Answers will also determine the level of integration between the contact
center systems and the workforce database
The flexibility of the appointment setting process and/or system.
The performance levels achieved in meeting appointment commitments.
The degree of alignment of the customer service system with customer
needs as well as the productivity potential of the appointment setting
process - the higher the appointment rejection, potentially fewer calls per
hour.
The flexibility of the scheduling system to accommodate a last-minute
customer change
The customer-centricity of the customer-service-center interaction -
scenario assessment, potential solution recommendations that fit with
service upgrades and current promotions, CSR incentives and training to
upsell, etc.
Whether performance of CSRs is tracked by length of call
Whether revenue up-selling is part of CSR performance tracking
whether performance of CSRs is tracked by time to get to resolve
specific customer problems or appointment challenges
Whether performance of CSRs is tracked by the time it takes them to
answer a new call
Whether performance of CSRs is tracked by customer satisfaction with
the interaction
whether performance of CSRs is tracked by their ability to accurately
diagnose a problem with the customer
The degree of integration between the CRM system, the appointment
management and dispatch systems

TABLE 2
Work Management (set P2)

The flexibility of the system and/or the field asset management process
The ability of the dispatch system to dynamically handle load imbalances
or jeopardies
The degree of automation inherent in the dispatch system and processes
The ability of the dispatch system to dynamically optimize and assign
work based on skills and skill availability
If the dispatch system is capable of being configured with auto-
contingency capabilities as a way to ensure a higher level of service
commitment fulfilment
The accuracy of the dispatch system in matching appointment
commitments with all of the resources requirement to fulfill those
commitments
The accuracy of the initial problem diagnosis and the service solution
dispatched by the system to solve the problem in the forecasted time
allotted
The frequency in which insufficient resource capacity (i.e. techs, special
inventory, specialized equipment) create missed commitments
The degree of scheduling automation from one day to the next
The degree to which the dispatch system automatically sequences the
work items for a particular job according to different company resources
required at certain job stages.
The scalability of the dispatch system to manage and schedule a broad
spectrum of different job types
The degree of automation in the dispatch system - thereby determining
the cost-efficiency
The accuracy (or quality) of dispatch - right tech with the right skills,
tools, equipment and parts matched to the right problem
How long it takes to create a satisfied customer

TABLE 3
Asset Management (set P3)

The assignment efficiency of the dispatch system in getting the tech to
their first job
The ability of the work dispatch system to minimize travel time - thereby
decreasing costs and increasing tech productivity
The ability of the work dispatch system to intelligently and automatically
assign techs' next jobs close to their last jobs
The unproductive time spent in the work center at the end of the day
The number of jobs for which testing is done automatically before they
are closed
Tech productivity
Tech customer effectiveness - i.e. accuracy of original diagnosis,
accuracy/quality of dispatch, quality of customer communications to
ensure tech ability to access the premises
Scalability of the dispatch system to dispatch and manage a broad
number of tech types and mob types
Worker management breadth of a single instance of the dispatch system
The accuracy/quality of dispatch decisions made by the dispatch system
The speed and competency of individual techs
The amount of travel time per tech per day - thereby benchmarking a
critical tech productivity drain
The ability of the dispatch system to automatically assign last jobs to
capable techs close to their ending location
The degree that the system enables the ability to track the time and
locations that techs meet around formal or ad hoc breaks
The degree that the company benchmarks and tracks the efficiency and
accuracy of worker assignments and completions
The degree that the company monitors tech performance metrics
The “effective” automation in the dispatch system by how efficiently it
enables worker performance management
Whether tech travel time efficiency is tracked in the worker management
performance metrics

TABLE 4
Delivery Management (set P4)

The frequency in which service status is communicated between the
company and the customer
The frequency in which tech ETA is communicated proactively to the
customer
The frequency in which job close outs are confirmed with the customer
The accuracy of the tech ETA forecast
Whether quality testing is standard practice for new service installations
Whether quality testing is standard practice for repairs
Whether quality testing is standard practice in the completion of routine
maintenance jobs
Whether job close-out is standard practice upon job completion
The degree to which standard time allocations are set for different job
types
The number of jobs that are closed immediately upon completion
The proportion of customer “no-shows” - thereby determining cost
inefficiency
Whether tech up-selling is standard practice
The up-selling effectiveness of the tech workforce
The degree to which customer satisfaction surveying is standard practice
following job completion
How effectively the dispatch system makes automated tech assignment
decisions
The percentage of satisfied customers from a quality of work perspective
Whether service delivery performance is tracked

Any given service reviewer (which is to say the software running on a terminal 6a . . . 6e associated with a respective organisation) can register with the assessment tool server S1 so as to define the sets of parameters that are of interest to their organisation. Alternatively the assessment tool server S1 can profile the organisation according to a default set of parameters. Either way, once the service reviewer has registered with the assessment tool server S1, the service reviewer can thereafter request assessment of their organisation using a tool according to embodiments of the invention.

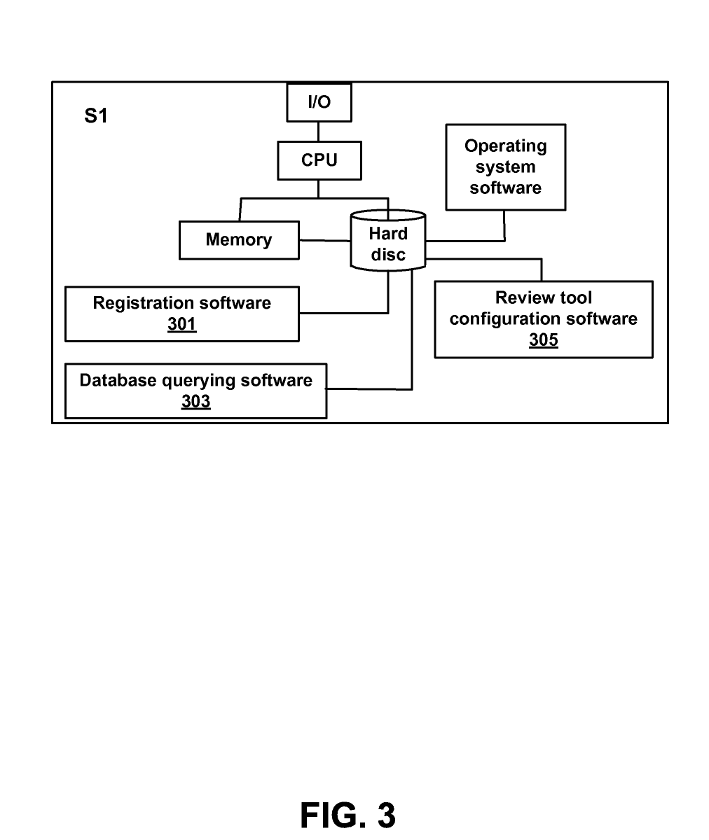

Turning now to FIG. 3, an arrangement of the assessment tool server S1 will now be described. The assessment tool server S1 is preferably embodied to communicate with a requesting terminal 6a . . . 6e associated with a service reviewer as a web server; the assessment tool server S1 comprises standard operating system, storage, processor, input/output interfaces, together with includes various bespoke software components 301, 303, 305. These latter software components are arranged, respectively, to receive a registration request for the assessment service, and indeed updates to a given account (registration software component 301), to query the database DB1 on the basis of the identity of the requesting service reviewer in order to identify parameters of interest to the querying service reviewer (database querying software component 303), and to configure a review tool on the basis of the identified parameters of interest (review tool configuration software component 305). In addition, the review tool configuration software component 305 is arranged to send data to, and receive data from, the terminal 6a . . . 6e associated with the service reviewer to enable generation of the review tool.

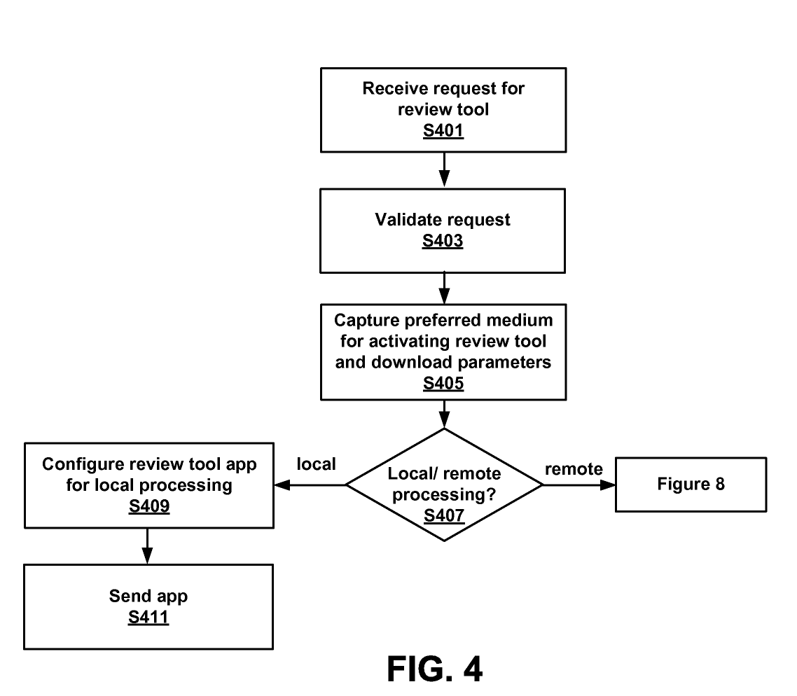

Turning to FIG. 4, the steps performed by the assessment tool server S1 when interacting with a service reviewer in a first embodiment will now be described. In a first step (S401), the assessment tool server S1 receives a request for a review tool from one of the terminals 6a . . . 6e. This request can be transmitted as an electronic (e-mail) message, as an SMS (Short Message Service) message, or as an application-specific message. In the event that the request is received as an e-mail or SMS message, the body of the message is formatted according to a pre-specified definition, which, for example, can be notified to the terminal 6a . . . 6e by the registration software component 301 when the service reviewer registers with the assessment tool server S1. In the event that the request is embodied as an application-specific message, this will have been transmitted by a bespoke application running on the terminal 6a . . . 6e, which may, for example, have been configured on the terminal 6a . . . 6e under control of the registration software component 301 as part of the registration process.

Once the request has been received by the assessment tool server S1, it is passed to the database querying software component 303, which validates the request with recourse to organisation records stored in the database DB1 (step S403). Assuming the request to be successfully validated, the database querying software tool sends a message to the terminal 6a . . . 6e of the requesting service reviewer, the message requesting details of the preferred medium for activating the review tool (step s405). The message can be sent as an e-mail message, an SMS message, or as an application-specific message, in the manner described above. Alternatively, and in the event that the service reviewer specified the preferred medium as part of the registration process, the database querying software component 301 retrieves details of same from the record corresponding to the querying service reviewer.

Having received the preferred medium for activating the review tool at step S405, the database querying software component 301 retrieves all of the sets of parameters registered as of interest to the service reviewer (again, on the basis of the identity of the associated organisation), and passes these, together with details of the preferred medium, to the review tool configuration software component 305. At decision point S407 the review tool configuration software component 305 identifies whether the requesting service reviewer has requested for the tool to be executed locally (that is to say, on the terminal 6a . . . 6e) or remotely (that is to say, on the assessment tool server S1). As shown in FIG. 4, the method splits into two paths dependent on the output of the decision point. Considering firstly a service reviewer that has specified local processing of the review tool, the review tool configuration software component 305 generates an application that can be delivered to the terminal 6a . . . 6e for processing thereon (step s409).

In one arrangement this application is embodied as an excel file, which is to say an excel file containing fields that require manual input and macros that are linked to the fields so as to generate service assessment output. The fields in the excel file comprise questions that correspond directly to the parameters retrieved from the database DB1 when validating the request at step S403, and thus present service data that are meaningful to this service reviewer. Once the application has been configured, it is transmitted to the requesting terminal 6a . . . 6e (step S411).

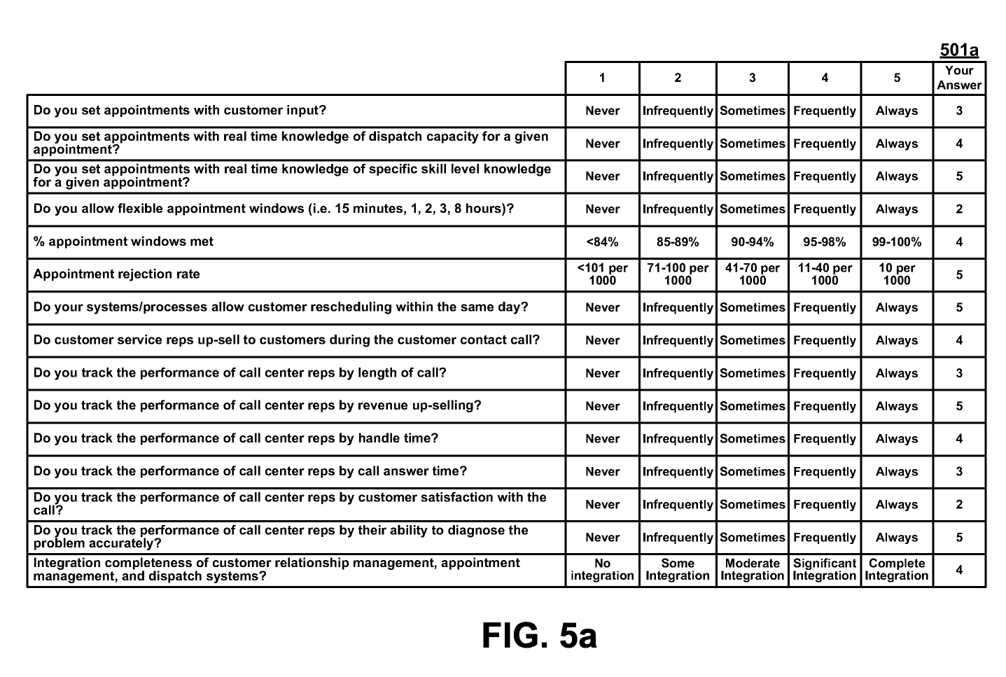

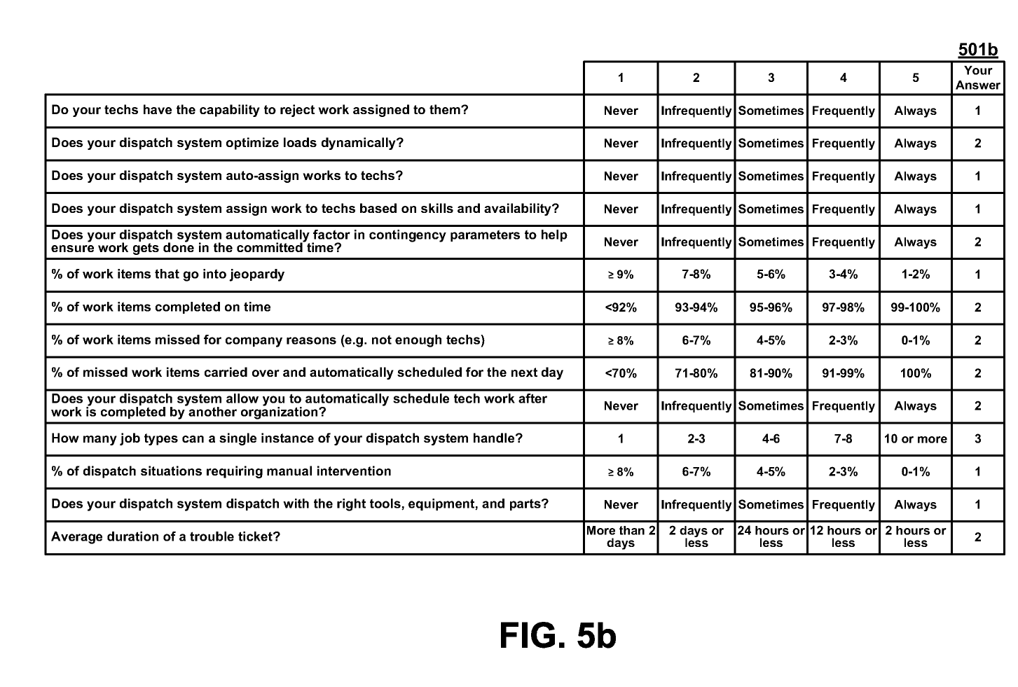

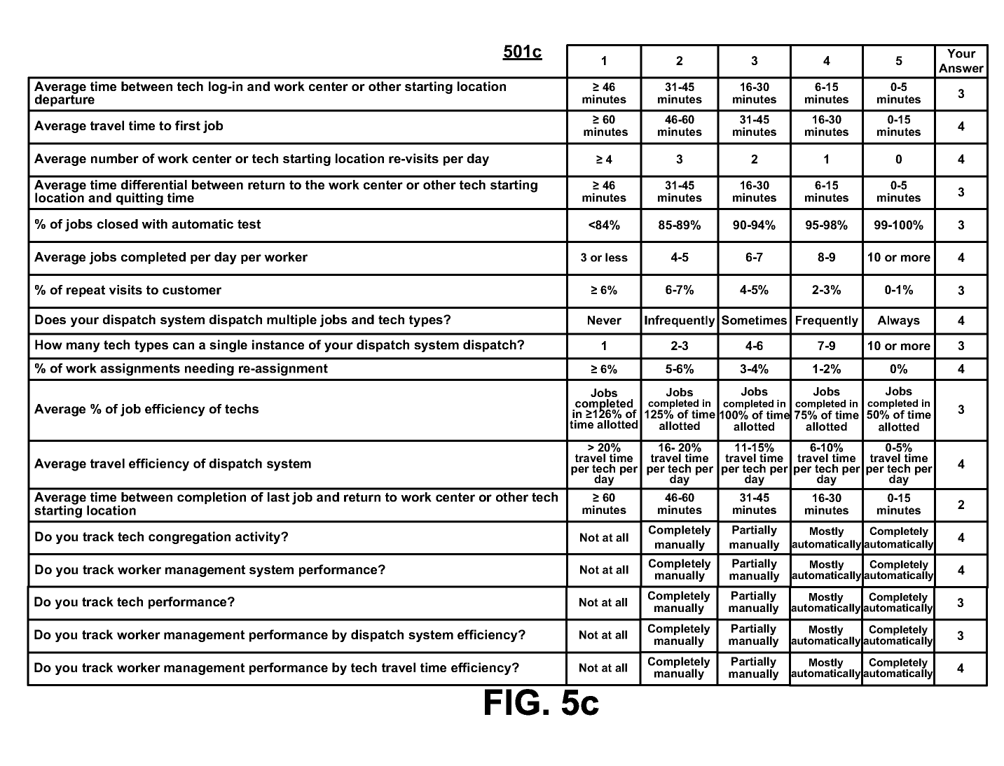

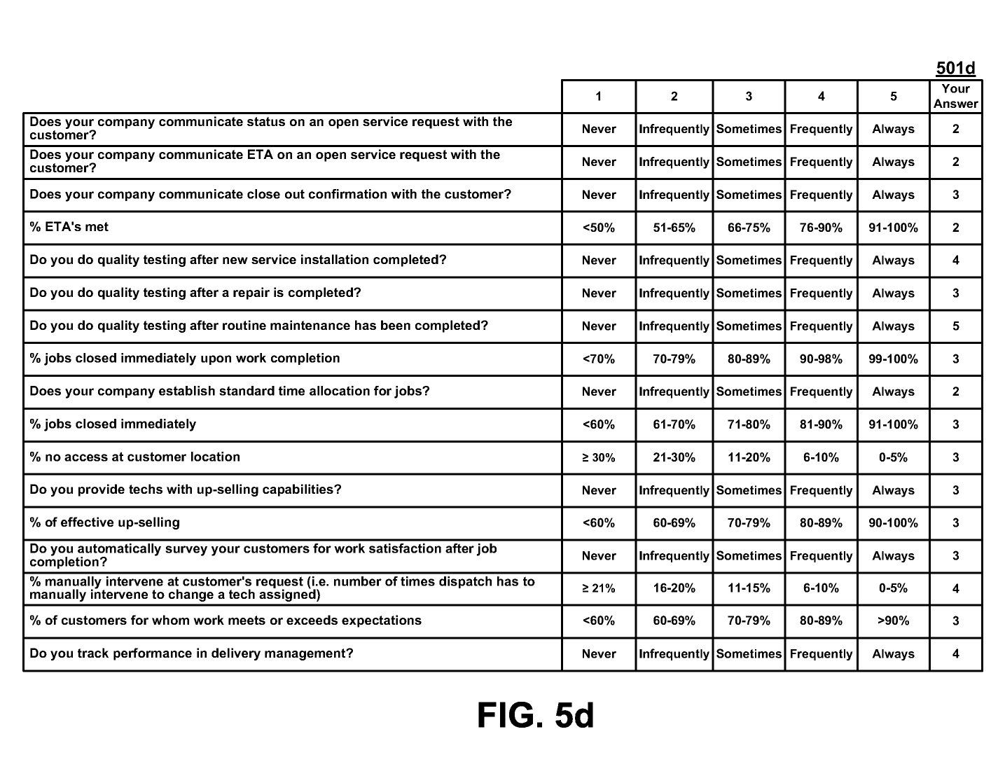

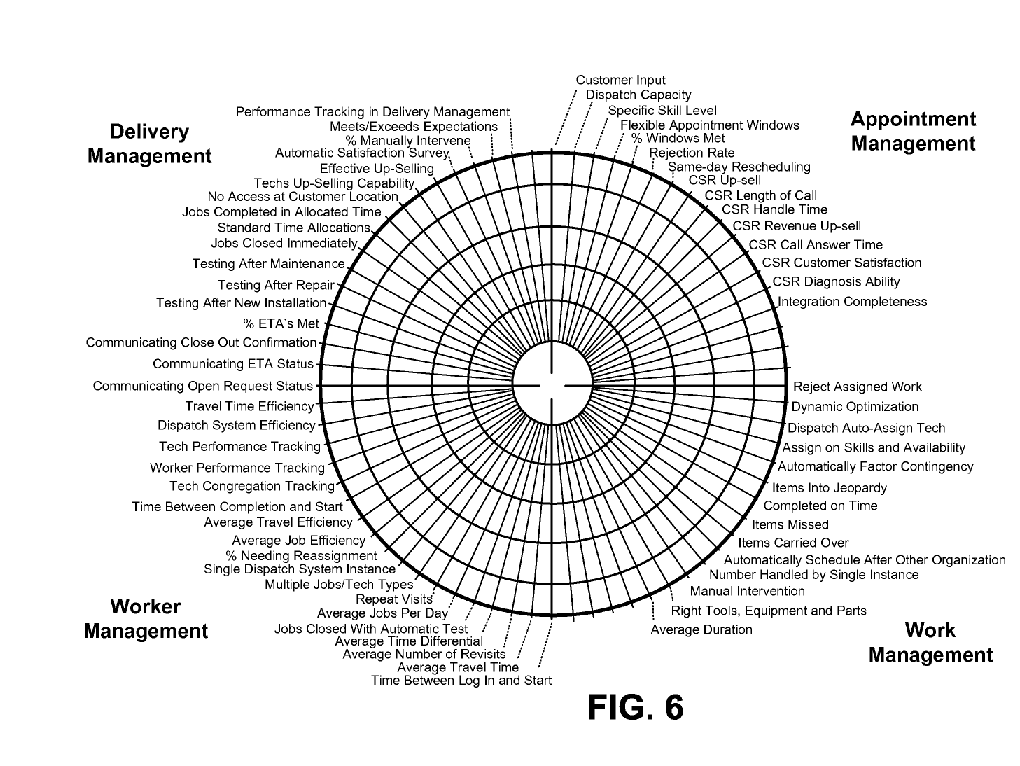

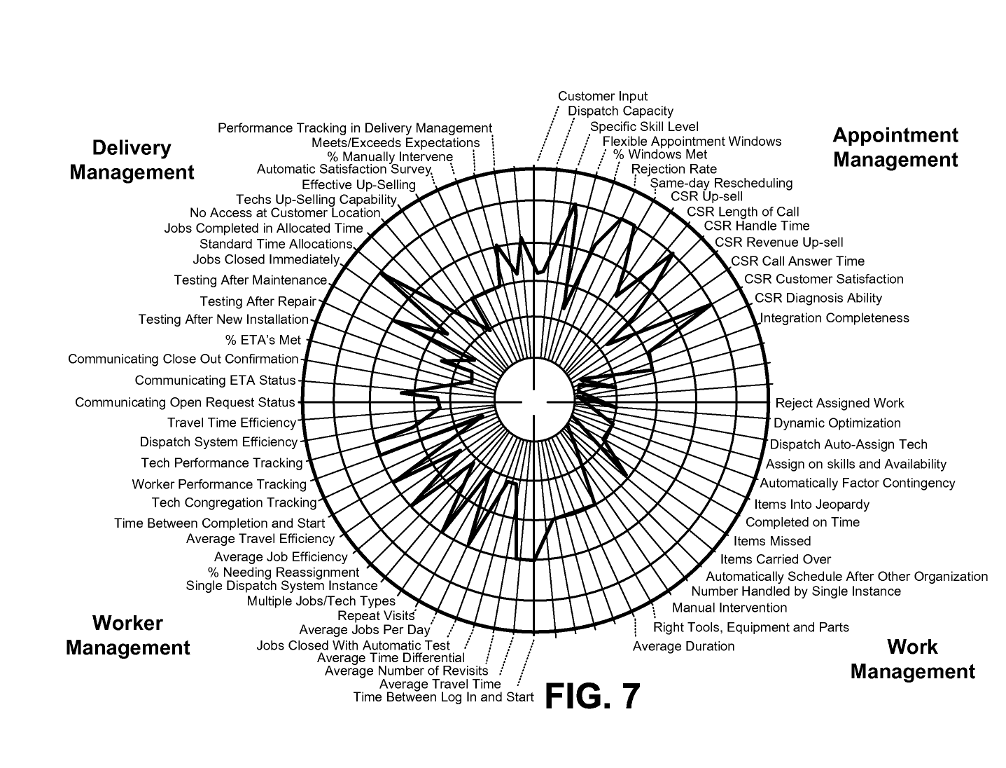

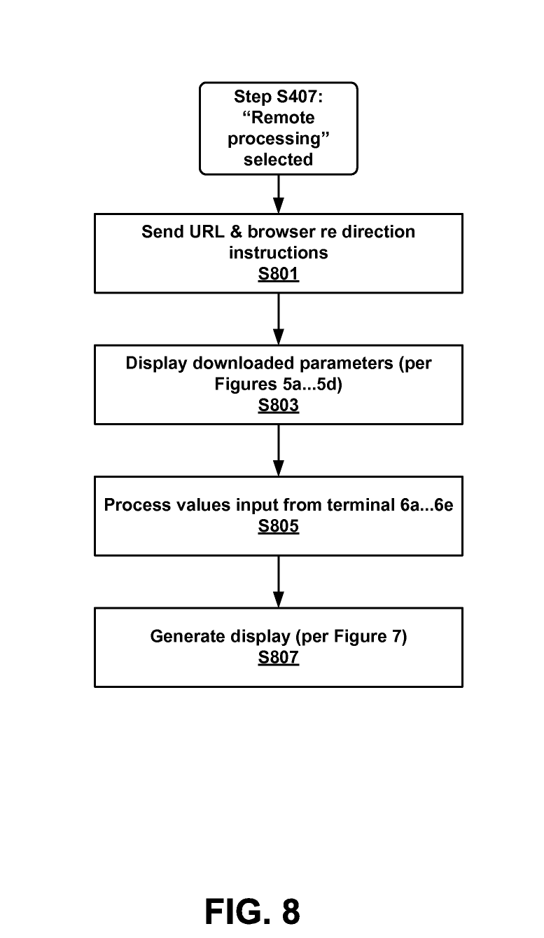

An example of these fields for a service reviewer corresponding to organisation A is shown in FIGS. 5a . . . 5d, from which it can be seen that the fields include questions corresponding to the parameters of each set P1 . . . P4, as listed in Tables 1-4 above. Moreover the fields include a column 501 to receive input from the user in relation to each of the questions. The input can be specified in the form of a quantifiable measure of performance, and in a preferred arrangement the input comprises a number within a predetermined range such as 1-5, as indicated in FIGS. 5a-5d. The excel file additionally comprises macros which operate on the data entered into columns 501a . . . 501d and that are configured to generate an integrated graphical display of the service data, which is to say the quantified data entered by the user. An example of the graphical display area into which the generated data is output is shown in FIG. 6, while FIG. 7 shows the display area after a user has input respective performance values into the respective columns 501a . . . 501d with the input data output therein. In this arrangement, the display area is a circle comprising four segments, each corresponding to a service area and each of which comprises as many sub-sectors as there are parameters; furthermore each segment has a plurality of radial markings, each corresponding to a score that can be entered into columns 501a-501d.

FIG. 7 demonstrates the advantages provided by a review tool according to an embodiment of the invention: the tool provides an integrated view of how a company is performing across the various service areas, and importantly highlights how the service areas are performing relative to one another. In the example shown, it is clear that the service area of work management performs relatively poorly compared to the other service areas. This enables the organisation to design and develop a structured approach to improving efficiency and business processes across the service areas, starting with those service areas performing most poorly. This is particularly advantageous when costs are an issue, and thus where it is important to effectively focus time, effort and resources into resources and new processes where they are most required. In addition it provides a means of benchmarking where an organisation is—relative to other organisations—and indeed in relation to previous performance of any given organisation.

As an alternative to configuring the review tool as an excel file, the tool can be configured as a Java™ application such as an applet, which is downloaded to the requesting terminal 6a . . . 6e suitable configured with a Java Virtual Machine (JVM) and thus adapted to run the applet when received thereon.

Turning back to FIG. 4, the steps performed by the review tool configuration software component 305 when the requesting terminal 6a . . . 6e indicates that the tool should be run remotely will now be described. In this embodiment, the assessment tool server S1 functions as a web application in addition to a web server. In one arrangement the terminal 6a . . . 6e is configured with a web browser, which is configured to run various Java Script code and thereby communicate with the web server of the server S1 so as to retrieve object data and transmit data requests. The web server is configured with a bespoke Servlet™ which communicates with the scripts running within the terminal browser using HTML and XML, preferably using Ajax™.

Accordingly, at step S801 the review tool configuration software component 305 sends an instruction to a browser running on the terminal 6a . . . 6e, the instruction containing a URL that directs the browser to the web server, together with a cookie (or similar) which can subsequently identify the requesting terminal 6a . . . 6e to the assessment tool server S1. Having received the relevant HTTP request, the web server running thereon invokes the associated web application and presents the requesting terminal 6a . . . 6e with a form, having content similar to that shown in FIGS. 5a-5d, and instructing the user to input quantitative measures of performance in relation to each of the sets of parameters retrieved by the database querying software component 303 (step S803). At step S805 the review tool configuration software component 305 processes the values input by the user of the terminal 6a . . . 6e—e.g. the values shown entered into the tables in FIGS. 5a-5d—and generates output that can be displayed in a display area within the browser of the terminal 6a . . . 6e in the manner shown in FIGS. 6 and 7.

In a further embodiment still, a set of forms could be sent to the user of the requesting terminal 6a . . . 6e as an attachment to an e-mail message, each set comprising the questions set out in FIGS. 5a-5d. Upon receipt of a completed form (e.g. by return e-mail), the review tool configuration software component 305 could parse and process the values input by the user of the terminal 6a . . . 6e, then generate output and store a file depicting, graphically, the generated output. This graphical output could similarly be e-mailed to the user of the terminal 6a . . . 6e as a file attachment, or alternatively a URL could be e-mailed to the user of the terminal 6a . . . 6e, directing the browser running on the terminal 6a . . . 6e to the web server where the file has been stored, for viewing via the browser.

In a yet further embodiment, the set of forms could be posted via regular mail to an office of a requesting service reviewer (whose postal details would be stored in DB1); upon receipt by an administrative office associated with the assessment tool, the completed forms could be scanned in and analysed using Optical Character Recognition (OCR) tools so as to derive the input manually entered by the service reviewer. Output could be generated in the manner described above, and the graphical output posted to the organisation associated with the service reviewer.

The above embodiments describe a scenario in which there are four sets of parameters, and in which data input in relation to each set of parameters is displayed in a segment, or sector, of a circle. Whilst the sectors are shown evenly distributed within the circle, they could alternatively be weighted so as to generate an uneven distribution, for example, with a relatively larger segment being assigned to whichever set of parameters the organisation scores most poorly so as to enable the reviewer to analyse the poorly performing areas in more detail. The relative sizes of the segments could be determined on the basis of how the sum of the parameters within a given set compare to that of the other sets. For example, in the example shown in FIG. 6, the combined score of the set of parameters corresponding to appointment management as shown in FIG. 5a is 58; that corresponding to work management as shown in FIG. 5b is 23; that corresponding to asset management as shown in FIG. 5c is 63; and that corresponding to delivery management as shown in FIG. 5d is 52. Thus if the sectors were to be inversely scaled according to relative performance, appointment management would be assigned 73.5° of the circle, work management would be assigned 137.7° of the circle, asset management would be assigned 64.3° of the circle and delivery management would be assigned 84.5°, and in this way ensure that visual focus is on the most poorly performing sector. Full details of calculations performed when identifying the scaling are as follows:
Overall score: 196 (58+23+63+52); four equal quadrants would score 49 each; thus

appointment management scored higher by 9

work management scored lower by 26

asset management scored higher by 14 and

delivery management scored higher by 3
Thus sector calculations:

appointment management: 90°×(1−(9/49))=73.5°

work management: 90°×(1−(−26/49))=137.7°

asset management: 90°×(1−(14/49))=64.3°

delivery management: 90°×(1−(3/49))=84.5°
Such a scaling algorithm could be provided as an integrated part of the excel macros, which operate on the input values in the manner described above.

Whilst the above description exemplifies the invention by means of four sets of parameters, it is to be appreciated that fewer, or indeed more, than four could be used. Indeed, as shown in FIG. 2, it may be that any given organisation only specifies a subset of available sets of parameters as being relevant for evaluating the performance of their organisation (or indeed third parties providing service thereto). It will also be appreciated that the number of segments populated graphically by the review tool configuration software component 305 will relate directly to the number of sets of parameters.

In addition, whilst in the above exemplary embodiment a circle is used to depict the entered performance values, it will be appreciated that other shapes, indeed including three dimensional shapes, may be used to display the output, and that the shape may comprise a part-circle such as a hemisphere

In the above embodiments, it is assumed that an organisation has only one business unit that will be assessed in relation to the service areas described above, or at least that the business units making up the organisation are sufficiently harmonised that a single value can accurately reflect service effectiveness across all units of the organisation. For such organisations it is of course a straightforward matter to assign a single value for a given parameter of the respective service areas; however, other organizations may operate quite independently of one other, with the result that any measure of performance may vary considerably for any given parameter of a given service area. For example, telecommunications companies typically offer Plain Old Telephone Service (POTS), Digital Subscriber Line (DSL), Internet services (ISP) etc., among other services, and each of these services is managed and operated by a different team. Accordingly, whilst there is a significant degree of overlap between the services provided and indeed the equipment utilised to provide the services, since the delivery of these services is managed on a per business unit basis, the delivery of the services may vary considerably between business units. Thus embodiments of the invention provide a means for assessing service effectiveness per business unit in order to enable the organization to establish effectiveness and failing areas per business unit.

More specifically, the review tool configuration software component 305 is arranged to process and generate individual display areas for each business unit, each being of the form shown in FIG. 6 (e.g. one circle for POTS services, one for DSL services etc.). The display areas can collectively be presented to the reviewer as an n-dimensional set of circles, together with a set of graphical configuration tools which enable selection of individual ones of the circles, thereby enabling the reviewer to add or remove individual display areas. In addition the review tool configuration software component 305 can generate average and standard deviation values for each parameter of a given set of service areas, thereby enabling the reviewer to identify relative performance between business units for any given aspect of the services provided by the service as a whole.

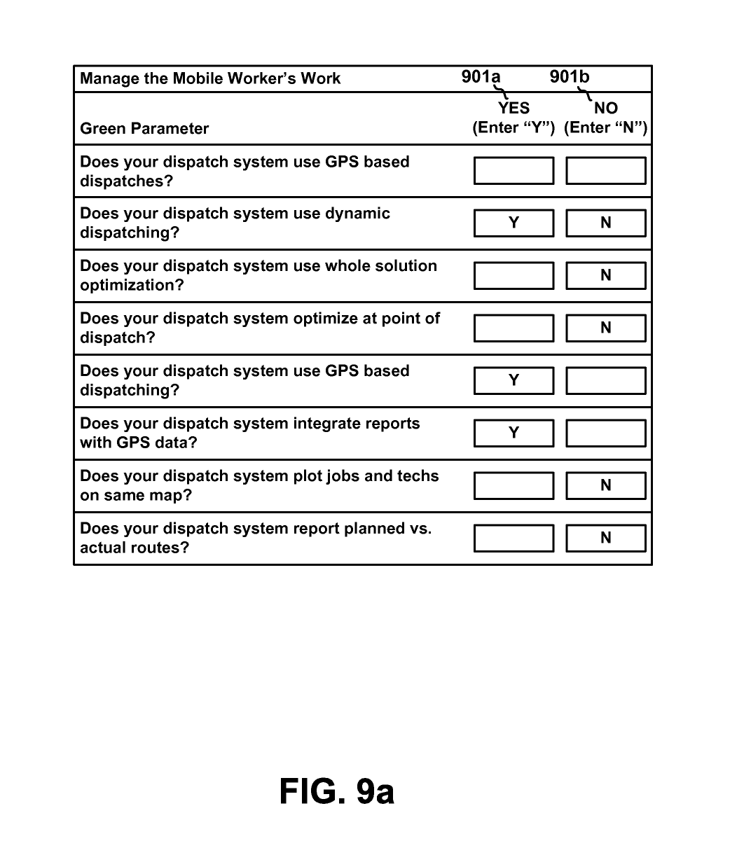

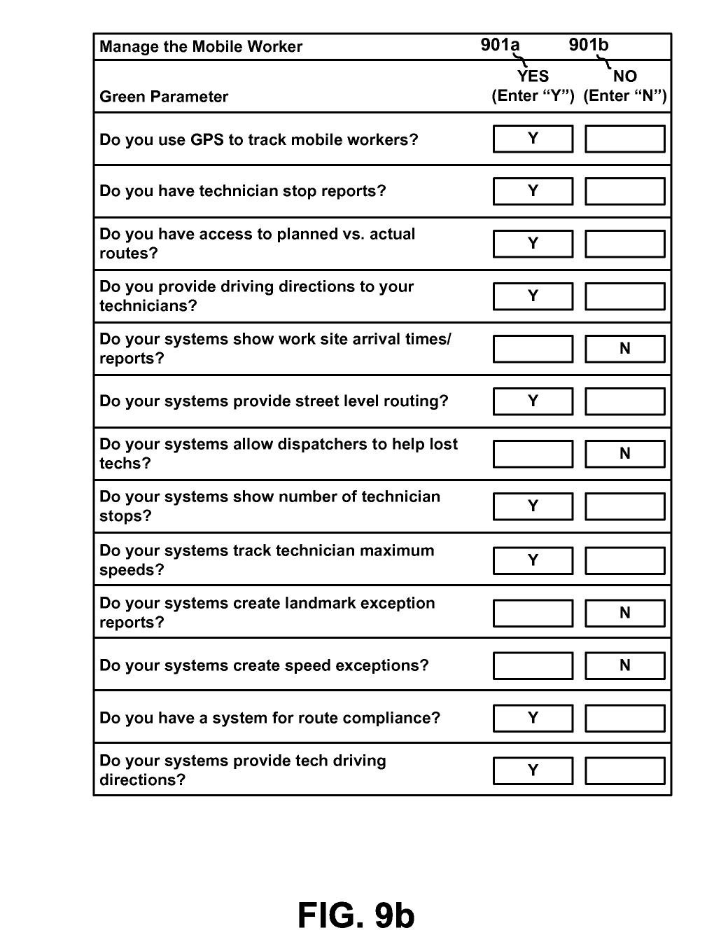

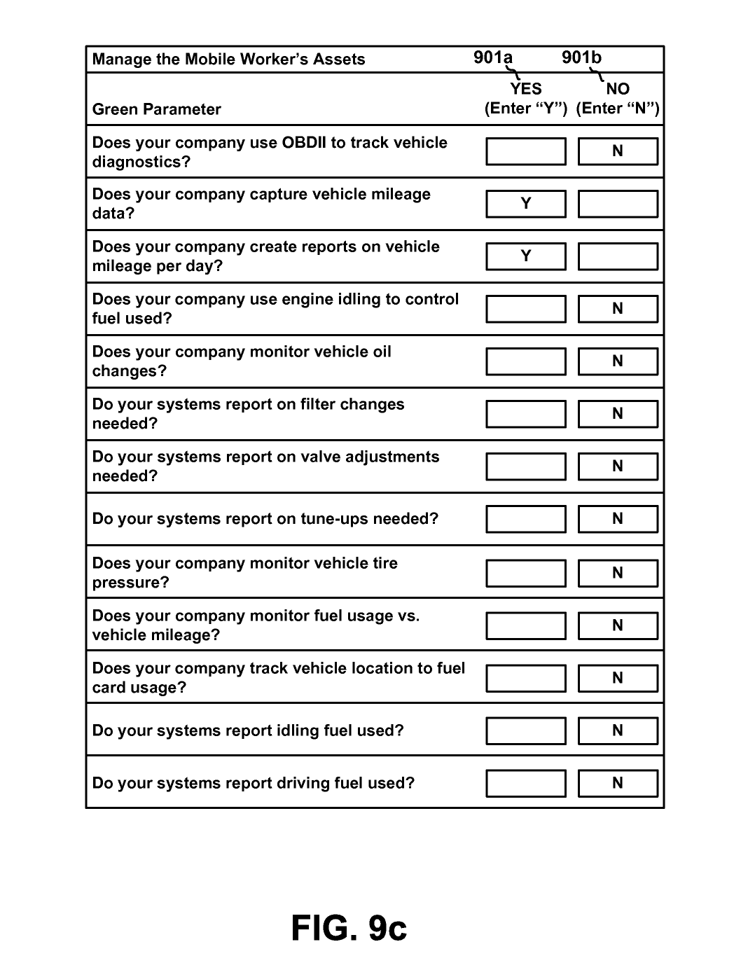

Referring now to FIGS. 9a-9c, a further embodiment of the invention, which involves assessment of environmental aspects of how the mobile worker is managed by the organisation, will now be described. These environmental areas comprise managing the mobile worker's work (FIG. 9a); managing the mobile worker (FIG. 9b); and managing the mobile worker's assets (FIG. 9c). In this embodiment the “score” entered by a given reviewer is a binary input of the form “Yes/No”, individual ones of which, for each environmental area, can be combined so as to give an overall score either for individual environmental areas, or for the combined environmental areas. In the event that the scores are combined per individual micro-service area, a graphical representation thereof can be generated in the manner described above, so as to enable identification of the relative inexperience of a given aspect of the mobile worker's management. This in turn enables a given reviewer to identify particular aspects of the mobile worker's management that should be improved so as to harmonise, environmentally, the mobile worker across the various areas of the organisation.

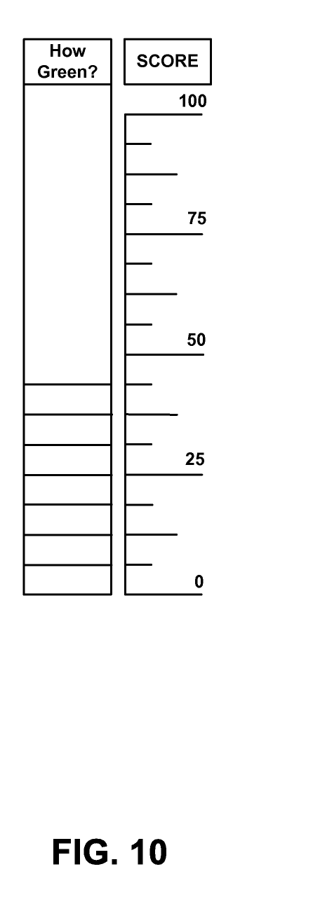

In the event that the scores from individual environmental areas are combined, an overall score can be generated. Accordingly, the application configured at step S409 (or accessed at step S803) can comprise a further interface and corresponding executable instructions, which capture input from the user in relation to the individual environmental areas, and generate a measure of fuel usage. An example of output so generated is shown in FIG. 10, for the example set of inputs entered by a given service reviewer shown in columns 901a and 901b of FIGS. 9a-9c.

### Additional Details and Modifications

As described above, the service reviewer software can run on mobile terminals or fixed terminals. In relation to mobile devices, the terminals can be mobile telephones or PDAs, lap top computers and the like, and the mobile network 10 can comprise a licensed network portion (such as is provided by cellular networks using e.g. Global System for Mobile Communications (GSM) technology, Wideband Code Division Multiplex Access (WCDMA); Code Division Multiplex Access (CDMA), WiMax) and/or unlicensed network portions (such as is provided by Wireless LANs and Bluetooth technologies). The gateway GW 8 facilitates communication between the mobile network 10 and the Internet 12 and can be configured as a GPRS support node (GGSN) forming part of the mobile network 10.

Whilst FIGS. 5a . . . 5d show examples of metrics and threshold trigger points that can be utilised by a tool configured according to an embodiment of the invention, it will be appreciated that such metrics are likely to be sector and industry specific. Thus a more specialised version may be appropriate for industries/verticals with measurement criteria that relate more closely to that vertical.

Furthermore, it will be appreciated that the service areas listed above, namely appointment management, work management, asset management, and delivery management are exemplary and that both the number of sets of parameters and indeed the parameters in the sets can change. In relation to the embodiment described above, it is to be noted that the appointment management service area could usefully be generalised to cover the area of commitment management where not all work is ‘appointed’ but completion commitments are still being made. This applies particularly in the network ‘build’ & proactive network maintenance contexts where the work is not directly customer-facing.

The above embodiments are to be understood as illustrative examples of the invention. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A method of presenting one or more sets of service assessment evaluation data, each set of service assessment evaluation data corresponding to services provided by one or by different service providers, the method comprising:
providing an integrated data collection platform; and
arranging the integrated data collection platform to receive the one or each set of service assessment evaluation data, and, for each said set, using the data collection platform to:
identify a quantifiable measure of performance for each member of the set; and
present the set of quantified performance measures in an integrated graphical display area such that relative performance between sets of service assessment evaluation data can be established.

2. A method according to claim 1, including arranging the integrated data collection platform to receive the one or each set of service assessment evaluation data via an HTTP communications channel.

3. A method according to claim 1, including arranging the integrated data collection platform to receive the one or each set of service assessment evaluation data via email.

4. A method according to claim 3, including parsing data received via email so as to derive the one or each set of service assessment evaluation data.

5. A method according to claim 4, including using Optical Character Recognition (OCR) so as to derive the one or each set of service assessment evaluation data.

6. A method according to claim 1, including arranging the integrated data collection platform to receive the one or each set of service assessment evaluation data via file transfer.

7. A method according to claim 6, including parsing data received via file transfer so as to derive the one or each set of service assessment evaluation data.

8. A method according to claim 7, including using Optical Character Recognition (OCR) so as to derive the one or each set of service assessment evaluation data.

9. A method according to claim 1, further comprising sending to the one or each service provider one or more sets of service assessment evaluation questions, and configuring the integrated data collection platform to receive said one or more sets of service assessment evaluation data corresponding thereto.

10. A method according to claim 9, including notifying the one or each service provider of a URL corresponding to a server arranged to serve said set of service assessment evaluation questions.

11. A method according to claim 1, further comprising:
sending to the one or each service provider a software component comprising a set of executable instructions arranged to invoke the integrated data collection platform; and
sending the one or each service provider one or more sets of service assessment evaluation questions,
wherein the software component is configured such that the integrated data collection platform receives said one or more sets of service assessment evaluation data corresponding thereto, whereby to present the set of quantified performance measures in an integrated graphical display area on a terminal local to said service provider.

12. A method according to claim 1, in which a set of service assessment evaluation data corresponds to management of appointing a task.

13. A method according to claim 1, in which a set of service assessment evaluation data corresponds to management of dispatching a task.

14. A method according to claim 1, in which a set of service assessment evaluation data corresponds to management of resources dispatched to a task.

15. A method according to claim 1, in which a set of service assessment evaluation data corresponds to management of a task.

16. A method according to claim 1, in which a set of service assessment evaluation data corresponds to task-completion management.

17. A method according to claim 1, including creating a display area comprising a plurality of portions, each said portion corresponding to a said set of service assessment evaluation data, each portion comprising a plurality of regions, each said region corresponding to a member of the corresponding set of service assessment evaluation data.

18. A method according to claim 1, further comprising using the integrated service delivery platform to manipulate the one or each set of service assessment evaluation data in accordance with one or more predetermined functions so as to identify said quantifiable measure of performance for each member of the set.

19. A method according to claim 18, in which the integrated service delivery platform executes the one or each predetermined function so as to generate a weighted or normalised set of service assessment data.

20. A method according to claim 19, in which the members of a given set of service assessment data are weighted or normalised with respect to other members of the set.

21. A method according to claim 19 or claim 20, in which the members of a given set of service assessment data are weighted or normalised with respect to members of at least one other set of service assessment data.

22. A method according to claim 17, in which, for each said set of service assessment evaluation data, the method comprises inserting points indicative of the quantified performance measures in a said region corresponding to the quantified performance measure, whereby to present the set of quantified performance measures in an integrated graphical display area such that relative performance between sets of service assessment evaluation data can be established.

23. A method according to claim 17, in which each said portion comprises a segment of a two-dimensional entity.

24. A method according to claim 23, in which the two-dimensional entity comprises a part circle, and each portion comprises a segment of the part circle.

25. A method according to claim 23, in which the two-dimensional entity comprises a full circle, and each portion comprises a segment of the full circle.

26. A system for presenting one or more sets of service assessment evaluation data, each set of service assessment evaluation data corresponding to services provided by one or by different service providers, the system comprising an integrated data collection platform,
wherein the integrated data collection platform is arranged to receive the one or each set of service assessment evaluation data, and, for each said set, to identify a quantifiable measure of performance for each member of the set and to present the set of quantified performance measures in an integrated graphical display area such that relative performance between sets of service assessment evaluation data can be established.

27. A system according to claim 26, comprising a server system in operative association with said integrated data collection platform, the server system being arranged to receive the one or each set of service assessment evaluation data via an HTTP communications channel.

28. A system according to claim 27, wherein the server system is arranged to transmit one or more sets of service assessment evaluation questions to the one or each service provider via the HTTP communications channel.

29. A system according to claim 27, wherein the server system is arranged to notify the one or each service provider of a URL corresponding to said server system so as to serve said set of service assessment evaluation questions.

30. A system according to claim 26, comprising an e-mail system in operative association with said integrated data collection platform, the e-mail system being arranged to receive the one or each set of service assessment evaluation data via email.

31. A system according to claim 26, comprising a file system in operative association with said integrated data collection platform, the file transfer system being arranged to receive the one or each set of service assessment evaluation data via file transfer.

32. A system according to claim 26, wherein the system is arranged to configure and send to the one or each service provider a software component comprising a set of executable instructions arranged to invoke the integrated data collection platform, wherein the software component is configured such that the integrated data collection platform receives said one or more sets of service assessment evaluation data corresponding thereto, whereby to present the set of quantified performance measures in an integrated graphical display area on a terminal local to said service provider.

33. A system according to claim 26, wherein the integrated service delivery platform is arranged to manipulate the one or each set of service assessment evaluation data in accordance with one or more predetermined functions so as to identify said quantifiable measure of performance for each member of the set.

34. A system according to claim 33, wherein the integrated service delivery platform is arranged to execute the one or each predetermined function so as to generate a weighted or normalised set of service assessment data.

35. A system according to claim 26, wherein, for each said set of service assessment evaluation data, the integrated service delivery platform is arranged to render points corresponding to values indicative of the individual quantified performance measures in respective regions of a display portion assigned to the set of service assessment evaluation data, whereby to present the set of quantified performance measures in an integrated graphical display area such that relative performance between sets of service assessment evaluation data can be derived.

36. A system according to claim 35, in which each said display portion comprises a segment of a two-dimensional entity.

37. A method according to claim 36, in which the two-dimensional entity comprises a part-circle or a full-circle, and each display portion comprises a segment of the part-circle or full-circle.
